(19) United States
(12) Patent Application Publication
(10) Pub. No.: US 2007/0020428 A1
(43) Pub. Date: Jan. 25, 2007

(54) Round-placemat

(76) Inventor: Cynthia Ann Hernandez, San Antonio, TX (US)

Correspondence Address: CYNTHIA A. HERNANDEZ, 456 ALBERT WALK, SAN ANTONIO, TX, 78207, US

(21) Appl. No.: 11/184,458

(22) Filed: Jul. 19, 2005

(51) Int. Cl. B32B 3/02

(52) U.S. Cl. 428/66.6

(57) ABSTRACT

A round place mat with multiple layers of material adhered together for the use of round tables, in which case is constructed with four or more wedge-like mats connected together by the use of snaps on each side of the individual wedge leaving an open center. Once connected to each other will form a single place mat, and will cover a great portion of a round table.

### BACKGROUND OF THE INVENTION

The invention pertains to a multi-layered placemat which covers a great portion of the surface of a round table. The placemat is composed of two or more layers of material. The lower layer is that of non-skid texture, such as rubber, adhered to the center or top layer to provide a friction-gripping surface that is in contact with the supporting surface, such as table, for the place mat. The place mat could be produced from vinyl, plastic, or leather that would be cut sewn, or otherwise stitched as desired. The place mat could also be produced from polyethylene, and injection molding, which would be a standard approach to production. The placemat is comprised of four or more (depending on size of table desired) wedges joining each mat side by side with the use of snaps. The snaps, made of plastic material with multiple holes, run along side each individual place mat, and once overlapped, are easily attached.

### SUMMARY OF THE INVENTION

The foregoing objects and other features and advantages are provided by a place mat construction formed of tow or more layers of material, having durability once conjoined, these mats would effectively cover the surface of a round table. It would provide a protective barrier between the surface of a round table and scratches, stains, marks, or spills. And by placing additional snaps along the edge of a table and place mat, would not only provide great security but it would also increase the effective use of the round table.

An advantage of the present invention is that multiple designs could be incorporated on each mat, thus permitting the place mat to be adapted to different decor. The place mat, as well as being functional, could be produced in a wide range of colors and decorative designs as well as size, to accentuate and enhance the look of any kitchen, dining room, or living room. It could also be produced in a wide variety of children's themes.

A further advantage of this invention is that it is not only limited to household decor, but can also be displayed on round tables of elementary schools, daycare centers, and restaurants with the option for advertising space.

Finally, the present invention would be convenient, reasonably priced, reusable, elegant contemporary, eye-catching, attractive, easy to use, simple to clean, washable, easy to attach and easy to remove.

Other objects and advantages of the invention will be apparent from the following description in conjunction with the accompanying drawings.

### BRIEF DESCRIPTION OF DRAWINGS

FIG. 1 is a top view of the plan with an open center, discretely secured together with snaps.

FIG. 2 is a top view of the plan shown two parts seperated with view of snap adjustments.

FIG. 3 is a side view of the plan with view of two mats, and lower mat with upward snap, top mat with discrete hole facing south.

FIG. 4 is a bottom view of the plan with apparent snaps forming on solid mat.

FIG. 5 is a side plan view of lower mat snaps.

FIG. 6 is a bottom view of top layer snap holes

### DETAILED DESCRIPTION OF THE INVENTION

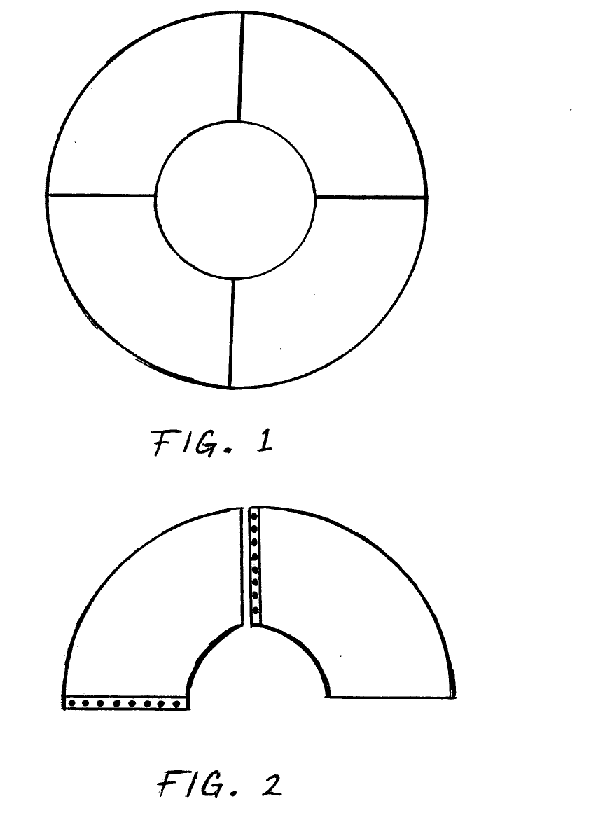

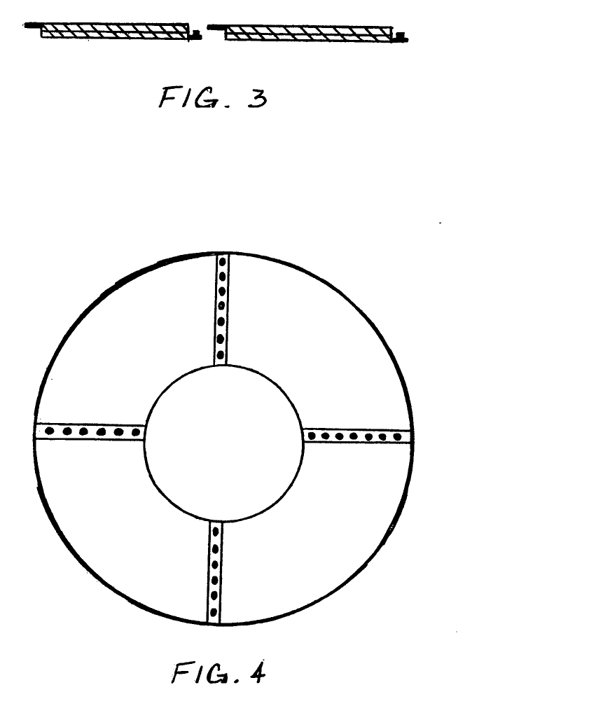

While this invention is susceptible of variation in size, there is shown in the drawings and will herein be described in detail preferred number of mats in the invention with the understanding that the present disclosure is to be considered as an exemplification of the principles of the invention and is not intended to limit the broad aspect of the invention to the drawings illustrated. FIG. 1 of the drawings discloses a serving mat such as a place mat with the exception that is in circular from with an opened center, and its divisions are in a group of four, but not limited to. FIG. 2 of the drawings discloses the round place mat in reference to FIG. 1, it is divided into two parts and shown seperately for clarity of the illustration and the obvious use of the lower-layered-non-skid-materials male snap adjustment located on the right side of each mat. FIG. 3 is illustrating two pieces side by side of the round place mat, and It is showing herein a double layered view of material which includes the lower non-skid texture connecting to the male snap adjustment on the right side of the mat. The second layer or top but not limited to, illustrates the adhered texture to lower layer of mat, and is connected to the female snap adjustment on the left side of the place mat in which will overlap and conjoin the lower mat with male adjustment on the right side of the place mat, which in turn would snap in place.

The illustration in FIG. 4 is that of the round place mat shown from its under side, with the apparent snaps in a fastened position. As illustrated in FIG. 1 The view plan is with open center. The under side or otherwise back side of the view plan in FIG. 4 consists of a non-skid material, such as rubber, for friction-gripping surfaces such as the preferred, round table.

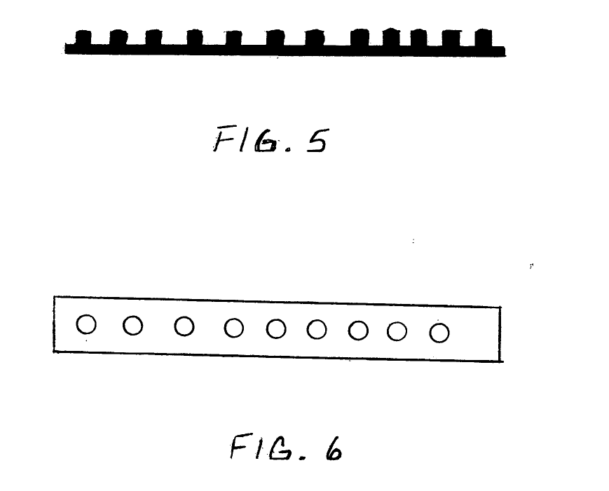

FIG. 5 of the drawings illustrates a side view of plan view male snap adjustment with multiple stump-like grooves produced of pliable plastic material, readily available items. These snaps will lay flat, facing upward along the right side of each place mat connected to the lower non-skid mat as illustrated in FIG. 4.

FIG. 6 is a bottom plan view of center or top layer place mat with apparent view of female hole-like snap adjustment. This structure, like that of FIG. 5, is also produced of pliable plastic material. FIG. 6 plan view is discretely adhered to under side of mat, and once flipped over to its correct side, these holes would then be located on left side of plan view.

With the construction described, it will be apparent that each mat is rendered ready for attaching and removing, and accordingly, has the strong possibility of not only functioning in a household but can also be displayed in elementary schools, day centers, and restaurants with the option for advertising.

What I claim as my invention is:

1. A place mat for round tables containing multiple layers of pliable plastic, vinyl, rubber and/or leather materials processed into a circular form and cut into wedge-like shapes which in turn conjoin by using readily available items, such as, male and female snaps, located on the right and left sides of each individual mat leaving an open center to form one single donut-like place mat.
